(19) United States
(12) Patent Application Publication
(10) Pub. No.: US 2008/0195687 A1
(43) Pub. Date: Aug. 14, 2008

(54) BUILDING MANAGEMENT SYSTEM AND METHOD

(75) Inventors: Hai-Young JUNG, Seoul (KR); Sang-Chul YOUN, Seoul (KR); Duck-Gu JEON, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 12/018,377

(22) Filed: Jan. 23, 2008

(30) Foreign Application Priority Data
Feb. 8, 2007 (KR) 10-2007-0013375

(51) Int. Cl. G06F 15/16; G05D 23/00

(52) U.S. Cl. 709/201; 700/276; 709/204

(57) ABSTRACT

A building management system and method are disclosed. The building management system includes: a central control system connected with a network and centrally controlling at least one sub-system accommodated in a building; a multi-air-conditioner system including an outdoor unit and one or more indoor units connected with the outdoor unit; a BACnet gateway serving as a connection passage of the central control system and the multi-air-conditioner system to allow the central control system to centrally control the multi-air-conditioner system; and a remote integrated management server that controls the multi-air-conditioner system by interworking with the BACnet gateway. Because detailed information can be managed through the remote integrated management server, that an existing building management system fails to do, the user convenience can be improved.

### BACKGROUND OF THE INVENTION

1. Field of the Invention

The present invention relates to a building management system and method and, more particularly, to a building management system and method capable of managing detailed information, that an existing building management system fails to do, through a remote integrated management server, thereby improving user convenience.

2. Description of the Related Art

FIG. 1 is a schematic view showing the structure of a building management system according to the related art.

As shown in FIG. 1, the related art building management system includes a central control system 10 connected to a network and centrally controlling subsystem such as power management or illumination equipment accommodated in a building, a multi-air-conditioner system 20 including an outdoor unit and one or more indoor units, and BACnet (Building Automation and Control network) gateways 30 serving as a connection passage between the central control system and the multi-air-conditioner system to allow the central control system 10 to centrally control the multi-air-conditioner system 20.

The basic function of the BACnet gateway 30 is to connect the multi-air-conditioner system 20 and the central control system 10. However, these days, the trend is that, in addition to functioning as a simple gateway, the BACnet gateway 30 performs various supplementary functions such as a self-diagnosing function, and various other functions that may help a person install the multi-air-conditioner system 20 are being developed.

With such a construction, the related art building management system performs management such that information related to a state of the multi-air-conditioner system 20 is transmitted to the central control system 10 via the BACnet gateway 30, and the central control system 10 controls the multi-air-conditioner system 20 via the BACnet gateway 30 based on the received information.

However, in the related art building management system, the multi-air-conditioner system 20 is connected with a larger-sized central control system 10 so as to be controlled. In this case, there is a limitation for the central control system 10 to control the multi-air-conditioner system 20 due to the capacity of the central control system 10 or other factors, failing to manage detailed information related to the multi-air-conditioner system 20, degrading the user convenience.

### SUMMARY OF THE INVENTION

Therefore, in order to address the above matters, the various features described herein have been conceived. One aspect of the exemplary embodiments is to provide a building management system and method capable of managing detailed information, that an existing building management system fails to do, through a remote integrated management server, thereby improving user convenience.

This specification provides a building management system that may include: a central control system connected with a network and centrally controlling at least one sub-system accommodated in a building; a multi-air-conditioner system including an outdoor unit and one or more indoor units connected with the outdoor unit; a BACnet gateway serving as a connection passage of the central control system and the multi-air-conditioner system to allow the central control system to centrally control the multi-air-conditioner system; and a remote integrated management server that controls the multi-air-conditioner system by interworking with the BACnet gateway.

The building management system may further include: an interworking module positioned between the BACnet gateway and the remote integrated management server and allowing the BACnet gateway and the remote integrated management server to interwork with each other.

This specification also provides a building management system that may include: an interworking module which is positioned between a BACnet gateway and a remote integrated management server serving as a connection passage of the central control system and the multi-air-conditioner system, and allows the BACnet gateway and the remote integrated management server to interwork with each other, wherein the interworking module periodically receives first information data from the multi-air-conditioner system, stores the received data, is connected with the remote integrated management server, and transmits the first information data.

The first information data may include information data related to the indoor units and ventilation.

The interworking module may include: a data updating unit that periodically updates data; a data transmission unit that transmits the updated data to the remote integrated management server; and a protocol unit that connects the data updating unit and the data transmission unit.

The protocol unit may use an XML (eXtensible Markup Language) to facilitate a variable extension.

This specification also provides a building management method that may include: periodically receiving and updating first information data of the multi-air-conditioner system; generating the received first information data as a tag available for a user definition and storing the tag; and transmitting the generated tag to a remote integrated management system.

The first information data may include information data related to the indoor units and ventilation.

The tag may be generated by using an XML protocol with good extensibility.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing the construction of a building management system according to the related art;

FIG. 2 is a view showing the construction of a building management system according to an exemplary embodiment of the present invention; and

FIG. 3 is a view showing the structure of a remote integrated management server in FIG. 2.

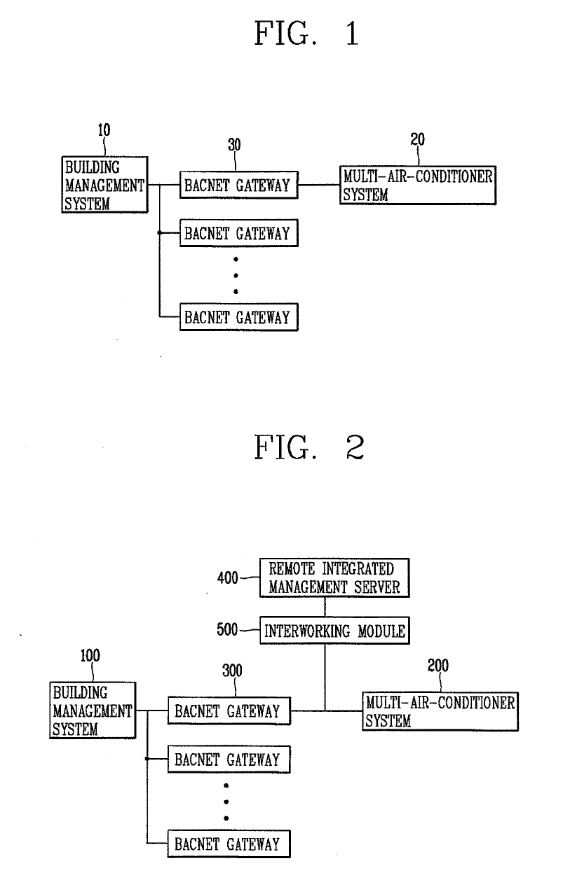

### DETAILED DESCRIPTION OF THE INVENTION

The present invention will now be described with reference to the accompanying drawings.

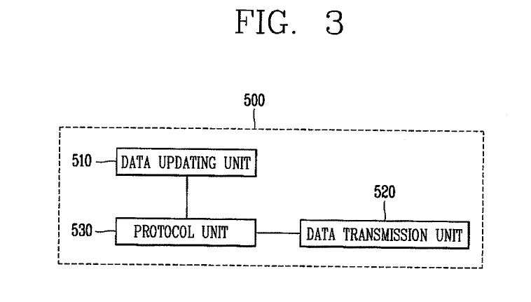

FIG. 2 is a view showing the construction of a building management system according to an exemplary embodiment of the present invention, and FIG. 3 is a view showing the structure of a remote integrated management server in FIG. 2.

As shown in FIGS. 2 and 3, the building management system according to an exemplary embodiment of the present invention includes: a central control system that centrally controls at least one sub-system of a building such as power management and illumination equipment; a multi-air-conditioner system 20; a BACnet gateway 300 that connects the central control system 100 with the multi-air-conditioner system 200 to allow the central control system 100 to centrally control the multi-air-conditioner system 200; and a remote integrated management server 400 that controls the multi-air-conditioner system 200 by interworking with the BACnet system 300.

An interworking module 500 may be provided between the BACnet gateway 300 and the remote integrated management server 400 to allow the BACnet gateway 300 and the remote integrated management server 400 to interwork with each other.

The interworking module 500 includes a data updating unit 510 that periodically updates data; a data transmission unit 520 that transits the updated data to the remote integrated management server 400; and a protocol unit 530 that connects the data updating unit 510 and the data transmission unit 520.

The data updating unit 510 is connected with the central control system 100 and the BACnet gateway 300. The data transmission unit 520 is connected with the remote integrated management server 400. The protocol unit 530 is provided between the data updating unit 510 and the data transmission unit 520 so that it can generate transmitted data as a new tag and transmits the generated tag to the data updating unit 510.

The protocol unit 530 uses an XML protocol to facilitate a variable extension. The XML protocol can allows generation every information regarding an indoor and ventilation and transmission of the same, having the best expandibility among any other Web protocols without being restricted to diversity of information. In addition, the protocol unit 530 interworks such that small and detailed information, which may not be managed by the larger central control system 100, can be managed through a special (technical or professional) service, so that the convenience of users who use the multi-air-conditioner system 200 can be improved.

With such a construction, the building management system according to the exemplary embodiment of the present invention is operated as follows.

Namely, the interworking module 500 is provided between the BACnet gateway 300 and the remote integrated management server 400 serving as a connection passage between the central control system 100 and the multi-air-conditioner system 200 to allow the BACnet gateway 300 and the remote integrated management server 400 to interwork with each other, and the interworking module 500 periodically receives data regarding the indoor units and ventilation from the multi-air-conditioner system 200.

The interworking module 500 reads the data regarding the indoor units and ventilation, stores XML tags for including each information and the respective information in a buffer, is connected with the remote integrated management server 400, and periodically transmits the data to the remote integrated management server 400.

In this manner, upon receiving the detailed data related to the indoor units and ventilation through the interworking module 500, the remote integrated management server 400 can manage the small, detailed information, which was not possible in the related art.

As so far described, the building management system and method according to the present invention has such an advantage that because detailed information can be managed through the remote integrated management server, which is not possible in the existing building management system, the user convenience can be improved.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A building management system comprising:
a central control system that centrally controls at least one sub-system of a building;
a multi-air-conditioner system;
a BACnet gateway that connects the central control system with the multi-air-conditioner system to allow the central control system to centrally control the multi-air-conditioner system; and
a remote integrated management server that controls the multi-air-conditioner system by interworking with the BACnet gateway.

2. The system of claim 1, further comprising:
an interworking module connected between the BACnet gateway and the remote integrated management server that allows the BACnet gateway and the remote integrated management server to interwork with each other.

3. The system of claim 2, wherein the interworking module comprises:
a data updating unit that periodically updates data;
a data transmission unit that transmits the updated data to the remote integrated management server; and
a protocol unit that connects the data updating unit and the data transmission unit.

4. The system of claim 3, wherein the protocol unit uses an XML (eXtensible Markup Language) protocol to facilitate a variable extension.

5. A building management system comprising:
an interworking module connected between a BACnet gateway and a remote integrated management server that connects a central control system of a building management system with a multi-air-conditioner system, and allows the BACnet gateway and the remote integrated management server to interwork with each other,
wherein the interworking module periodically receives first information data from the multi-air-conditioner system, stores the first information data, and transmits the first information data to the remote integrated management server.

6. The system of claim 5, wherein the first information data comprises information data related to at least one of an indoor unit and a ventilation of the multi-air-conditioner system.

7. The system of claim 5, wherein the interworking module comprises:
a data updating unit that periodically updates data;
a data transmission unit that transmits the updated data to the remote integrated management server; and
a protocol unit that connects the data updating unit and the data transmission unit.

8. The system of claim 7, wherein the protocol unit uses an XML (eXtensible Markup Language) protocol to facilitate a variable extension.

9. A building management method comprising:
periodically receiving and updating first information data of a multi-air-conditioner system;
generating a tag from the received first information data and storing the generated tag; and
transmitting the generated tag to a remote integrated management system.

10. The method of claim 9, wherein the first information data comprises information data related to at least one of an indoor unit and a ventilation of the multi-air-conditioner system.

11. The method of claim 9, wherein the tag is generated by using an XML protocol.
